(19) United States
(12) Patent Application Publication
(10) Pub. No.: US 2020/0128840 A1
(43) Pub. Date: Apr. 30, 2020

(54) METHOD FOR PRODUCING A CHEESE STRING

(71) Applicant: BEL, SURESNES (FR)

(72) Inventors: Claude LEMOINE, VENDOME (FR); Jean Paul GREMILLET, SURESNES (FR)

(21) Appl. No.: 16/494,268

(22) PCT Filed: Mar. 13, 2018
(86) PCT No.: PCT/EP2018/056277

§ 371 Date: Sep. 13, 2019

(30) Foreign Application Priority Data
Mar. 15, 2017 (FR) 17 52115

(51) Int. Cl. A23C 19/08; A23P 30/20; A23C 19/068

(52) U.S. Cl. CPC A23C 19/08; A23C 2250/10; A23C 19/0684; A23P 30/20

(57) ABSTRACT

A method for manufacturing a cheese string involves providing a cheese base, retexturing the cheese base to form a cheese paste, and extruding the cheese paste through a die with a diameter less than or equal to 10 mm to form the cheese string, in which the cheese base has a maximum tangent δ slope value of between 0.06 and 0.10.

### PRIORITY AND CROSS REFERENCE TO RELATED APPLICATIONS

This application is the U.S. National Phase Application under 35 U.S.C. § 371 of International Application No. PCT/EP2018/056277, filed Mar. 13, 2018, designating the U.S. and published as WO 2018/167084 A1 on Sep. 20, 2018, which claims the benefit of French Application No. FR 17 52115, filed Mar. 15, 2017. Any and all applications for which a foreign or a domestic priority is claimed is/are identified in the Application Data Sheet filed herewith and is/are hereby incorporated by reference in their entireties under 37 C.F.R. § 1.57.

### FIELD

The present invention relates to cheese strings.

### SUMMARY

The present invention relates to a method for manufacturing a cheese string.

### BRIEF DESCRIPTION OF THE DRAWINGS

The invention is illustrated by the following figures and examples which do not limit the scope thereof.

FIG. 1: Value of the maximum tan delta slope on samples of traditional pressed paste and cheese base according to Example 2 of WO 02/096209.

FIG. 2: Mettler Toledo DP70 drop point measuring device.

FIG. 3: Example of visual inspection of the sample during the test.

### DETAILED DESCRIPTION

The present invention relates to a method for manufacturing a cheese string.

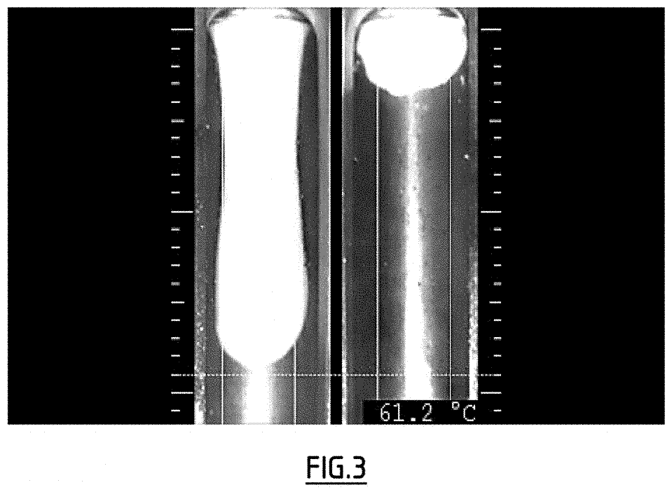

Methods of producing cheese strings are known from the prior art. For example, WO2011110184 discloses a method for producing a cross-linked dairy product from cheeses, wherein cheeses are cooked and additives added to the cheeses to form a mixture, wherein the mixture is extruded into cheese strings, and then shaped. The diameter of a cheese string obtained by this method is less than or equal to 4 mm. However, a photograph of a string in FIG. 3 shows that the diameter of the string is very variable, and that the string may have many variations on its surface. In terms of aesthetics, such variability may not be appreciated by consumers.

It is also known that the extrusion of cheese strings at a high industrial rate is difficult to implement in order to obtain a cheese string whose diameter is constant and of regular cross-section.

EP0727138 discloses a method for continuously manufacturing a cheese string from a curd and/or a retentate obtained by ultrafiltration of a milk. In this method, the comminution, cooking and extrusion steps are implemented inside the same sheath. In certain embodiments of the method described in EP0727138, additives, especially emulsifying salts, are added to obtain the desired texture after extrusion. In fact, it is known that the addition of emulsifying salts facilitates extrusion by giving the cheese to be extruded a softer texture. In the context of the present invention, it is desired to obtain a natural cheese, i.e. free of any additive.

Moreover, commercial cheese strings often have a matt appearance reflecting an inhomogeneity of the surface of the string.

Thus, the technical problem to be solved by the present invention is to obtain a cheese string of substantially constant diameter of less than or equal to 10 mm, while maintaining an industrial rate of production. Other desired objectives are that the cheese string obtained is natural, that the cheese string has a regular cross-section, and that it has a glossy appearance reflecting homogeneity of the surface of the string and the absence of variations.

Method for Manufacturing a Cheese String

The invention thus relates to a method for manufacturing a cheese string, the method comprising the supply of a cheese base, the retexturing of this cheese base to form a cheese paste, and the extrusion of this cheese paste through a die with a diameter less than or equal to 10 mm to form the cheese string, wherein the cheese base has a maximum tangent δ slope value of between 0.06 and 0.10.

Cheese Base

The cheese base used in the manufacturing method according to the invention consists of a cheese product.

By “cheese product” or “cheese” is meant here any product obtained by coagulation, fermented or not, refined or not, mainly obtained from materials of dairy origin, which may include raw materials of plant origin, for example vegetable fat, and water. However, the cheese product may contain in small amounts, coagulating agent, manufacturing auxiliary(ies), flavor(s), dye(s), preservative(s), but is preferably free of texturant, emulsifying salts and acidity correctors. The dry matter content (dry extract) of the cheese products is typically 25 to 60% by weight relative to the total weight of the cheese product.

According to one embodiment, the coagulation is carried out enzymatically.

According to a particular embodiment, the cheese base is a pressed cheese type product.

Codex Standard STAN 283-1978 proposes a classification of cheese products according to the water content of defatted cheese product (WCDC). Cheese products with a WCDC between 54% and 69% may be called semi-hard cheese products, while cheese products with a WCDC greater than 67% may be called soft cheese products.

The term “between” above is to be understood in a broad sense. Thus, a quantity A lies between a first value A1 and a second value A2 when, on the one hand, the quantity A is greater than or equal to the first value A1, while, on the other hand, the quantity A is less than or equal to the second value A2.

Typically, WCDC is calculated as follows: (Weight of water in cheese)×100/(Total weight of cheese−Weight of fat in cheese).

In the context of the present invention, the term “pressed cheese type product” is understood to mean a cheese product corresponding to the definition of semi-hard paste according to Codex STAN 283-1978.

The term “traditional young pressed paste” means traditional pressed paste type cheeses made less than a month before or having an age less than or equal to 1 month.

According to a particular embodiment, the cheese base is obtained by at least the following successive stages:
(1) caking or coagulating a standardized milk or a dairy concentrate by the action of a coagulating agent to form a curd,
(2) shaping the curd, drained or not, in molds,
(3) spontaneous or pressurized dewatering to obtain the desired solids content of the final product,
(4) optionally a salting or brining step, which confers on the cheese base the desired salt content and enables the formation of a superficial crust, and
(5) draining or dewatering

According to another embodiment, the cheese base is obtained according to the manufacturing method described in WO 02/096209. This cheese base is then constituted by a cheese product aged from 1 to 5 days old, having a degree of calcium/degreased dry extract mineralization less than 2% by weight relative to the total weight of the cheese base, and a flexible elastic paste, not friable, having a rheological profile that is substantially similar to that of pressed cheese. The manufacturing method described in WO 02/096209 comprises the steps of acidifying a milk to reach a pH value of between 5.2 and 5.8 before effecting the coagulation by adding to the milk a coagulating enzymatic preparation to obtain the required pH value.

Preferably, the cheese base used in the method according to the invention has a dry extract of between 50 and 60% by weight relative to the total weight of the cheese base.

According to a particular embodiment, the cheese base has a fat content less than or equal to 22% by weight relative to the total weight of the cheese base. A ratio of fat/dry extract is defined as being the ratio between the fat content by weight relative to the total weight of the cheese base and the dry extract by weight relative to the total weight of the cheese base.

According to a particular embodiment, the ratio of fat/dry extract of the cheese base is less than or equal to 45% by weight relative to the total weight of the cheese base, and is preferably between 20 and 40% by weight relative to the total weight of the cheese base.

A fat/protein ratio is defined as the ratio between the fat content by weight relative to the total weight of the cheese base, and the protein content by weight relative to the total weight of the cheese base.

According to a particular embodiment of the invention, this cheese base has a fat/protein ratio less than or equal to 0.8, preferably between 0.4 and 0.8.

Retexturation of the Cheese Base

By “retexturing” of the cheese base, is meant here a comminution of the cheese base followed by baking-kneading to give the cheese base a texture suitable for undergoing extrusion.

A cheese base prepared as described above is comminuted to form a comminuted material. A rotary blade type grinder or a pusher-type grinder is used to guarantee optimization of the heating operation.

The comminution is typically carried out at a temperature between 6 and 20° C. The comminution time is short and depends on the performance of the mill (of the order of a few seconds). The comminuted material is then transferred to a kneading apparatus to form a cheese paste.

The kneading-cooking is typically carried out in a sheath equipped with a screw, or devices of the kneader, mixer, kneader, cooker-mixer, or co-kneader type. The temperature of the comminuted material at the end of cooking is typically between 62 and 69° C., preferably 62 to 66° C. The average residence time of the comminuted material once the cooking temperature is reached, is typically between 180 and 540 seconds.

The cheese paste so obtained typically has a solids content of between 47% and 55% by weight relative to the total weight of the cheese paste.

According to a particular embodiment, the cheese paste may have a fat content less than or equal to 20% by weight relative to the total weight of the cheese paste.

According to a particular embodiment, the ratio between the fat content by weight relative to the total weight of the cheese paste, and the dry extract by weight relative to the total weight of the cheese paste, may be less than or equal to at 40%, preferably 20 to 40%.

According to a particular embodiment of the invention, the ratio between the fat content by weight relative to the total weight of the cheese paste, and the protein content by weight relative to the total weight of the cheese paste, is less than or equal to 0.75, preferably 0.6 to 0.7.

Advantageously, the cheese paste obtained is free of additives. For this purpose, neither the step of manufacturing the cheese base nor the retexturing step include the use of any additive.

“Additive” is understood to mean any substance which is not normally consumed as a food in itself and is not normally used as a characteristic ingredient of a food, whether or not it has nutritional value, and including intentional addition to the food for technological or organoleptic purposes at any stage of the manufacture, processing, preparation, packaging, transport or storage of the food product, that may cause, or may result in (directly or indirectly), its incorporation or that of its derivatives into the commodity or may otherwise affect the characteristics of the food (definition in accordance with Codex Standard Stan 192-1995 of the Codex Alimentarius). Mention may be made, for example, of emulsifying salts, texturants (emulsifiers, thickeners), preservatives, enhancers, acidifiers, antioxidants and dyes. The term does not apply to contaminants, substances added to foods for the purpose of maintaining or improving their nutritional properties, or to sodium chloride and ferments.

EU Regulation No. 1129/2011 of 11 Nov. 2011 contains in Part B of Annex II an exhaustive list of additives permitted in the European Union, including dyes, preservatives and texturizers.

“Aromas” is understood to mean flavoring substances, flavoring preparations, aromas obtained by heat treatment, smoke flavorings and flavor precursors as defined in Regulation (EC) No 1334/2008 of 16 Dec. 2008, which contains in Annex I an exhaustive list of flavorings authorized in the European Union.

In one embodiment of the invention, the method does not include the use of any additive selected from among emulsifying salts, texturizing agents (emulsifiers and thickeners) and acidity correctors.

In one embodiment, the method comprises injecting dye(s), flavor(s) and/or preservative(s). Preferably, according to this embodiment, the method does not include the use of any additive selected from emulsifying salts and texturizing agents (emulsifiers and thickeners).

The cheese paste obtained is the material to be extruded into a cheese string.

Advantageously, the retexturing step comprises an additional sub-step of elongation following the cooking.

Extrusion of the Cheese Paste

The cheese paste obtained after retexturing is extruded. Advantageously, no additive is added at this stage, or between the retexturing and extrusion steps.

The cheese paste is introduced into an extruder comprising a sheath equipped with two worm screws and a die downstream of this sheath. This die has an opening constituted by at least one orifice formed in the die and through which the cheese paste is forced. The, or each, orifice has a diameter less than or equal to 10 mm (millimeters). Preferably, the, or each, orifice has a diameter substantially equal to 9 mm. According to the example described, the, or each, orifice has a disc-shaped cross-section.

The cheese paste is kept at a temperature in the extruder.

The extrusion temperature is typically between 62° C. and 69° C., preferably between 62° C. and 65° C.

The extrusion parameters are designed to allow output of the cheese string from the extruder at a speed greater than or equal to 2.20 meters per minute. For this purpose, the pressure in the extruder is typically between 0.5 bar and 1.0 bar, while the ratio of the cross-section of the orifice of the die to the cross-section of the sheath is between 0.01 and 0.05.

The extrusion through the die is in a longitudinal direction.

Alternatively, the cross-section of the, or each, orifice may be another shape, for example a rectangle, a heart, a star, etc.

A length of the cheese string is defined as being the dimension measured in the longitudinal extrusion direction.

The cheese string has a cross-section substantially perpendicular to the longitudinal extrusion direction. The cross-section has a diameter. Hereinafter, the diameter of the cross-section will be called the diameter of the cheese string.

The cheese string obtained by the method of the invention has a substantially constant diameter at the outlet of the extrusion die.

“Substantially constant diameter” is understood to mean that two string diameter values measured at two distinct locations of this string have a variation less than or equal to 1%.

“Substantially constant diameter at the outlet of the extrusion die” is understood to mean that the diameter of the cheese string is substantially constant over a length of the cheese string at least equal to 10 times its diameter, preferably at least equal to 100 times its diameter.

The diameter of the cheese string is less than or equal to 10 mm. Preferably, the diameter of the cheese string is between 8 mm and 10 mm.

In addition, the cheese string at the outlet of the extrusion die has a regular cross-section. It is thus understood that the shape of the cross-section of a cheese string is substantially identical over a length of the cheese string at least equal to 10 times its diameter, preferably at least 100 times its diameter.

According to a particular embodiment, the extrusion is carried out continuously.

According to this embodiment, the cheese string obtained is continuous over a length of the cheese string at least 1000 times its diameter, preferably at least 4000 times its diameter, more preferably at least 8000 times its diameter. According to this embodiment, the cheese string obtained has a substantially constant diameter over a length of the cheese string at least 1000 times its diameter, preferably at least 4000 times its diameter, more preferably at least equal to at 8000 times its diameter.

Thus, the separation of the string into a plurality of strings of different lengths requires the use of a cutting tool.

In terms of aesthetics, the cheese string output from the extrusion die has a glossy appearance reflecting a homogeneity of the surface of the string and the absence of variations.

At the outlet of the extrusion die, a continuous cheese string having a substantially constant diameter and less than or equal to 10 mm, a regular cross-section, and a glossy, smooth and homogeneous appearance is described as being “compliant”.

The rheological characteristic of the maximum tangent δ slope of the cheese base is decisive for the quality of the cheese string obtained after extrusion. The tangent δ, also called tan δ, is typically measured using a rheometer on a cheese base sample to which a defined temperature ramp is applied under an imposed deformation and at a specific frequency.

For example, the applied temperature ramp is between 20° C. and 80° C. at a heating rate of 1° C./min, the imposed deformation is 1%, and the imposed frequency is 0.1 Hz.

In a measurement under oscillatory shearing, a sinusoidal deformation γ (or constraint τ) of pulsation ω is applied to a body during a time t. We measure a constraint τ (or deformation γ) itself a sinusoidal pulsation ω. If the deformation is of the form:

γ=γ₀ e^{iωt},

where γ₀ corresponds to the threshold deformation as of which the fluid flows, the constraint response being written in the linear domain:

τ=τ₀ e^{i(ωt+δ)},

where τ₀ corresponds to the threshold constraint from which the fluid flows, δ being the angle of loss between the constraint and the deformation.

The complex shear modulus G* is defined by:

$${G}^{*} = \frac{τ}{γ} = \frac{{τ}_{8}}{{γ}_{0}} {e}^{i δ} = {G}^{′} + {iG}^{″}$$

where G′ represents the real part of G*. It is the conservation module and it characterizes the response in phase with the deformation. It is associated with the elastic response.

G″ is the imaginary part of G*, it is the loss module. It is in quadrature phase with deformation and characterizes the viscous response.

$$tan δ = \frac{{G}^{″}}{{G}^{′}}$$

According to the example described, the cheese base has a maximum tangent δ slope value between 0.06 and 0.1, preferably between 0.07 and 0.09. Below 0.06, the cheese paste resulting from the retexturing of this cheese base is not extrudable at the temperatures in question, while the string has a heterogeneous appearance and presents risks of rupture. The string is of poor quality and is not continuous or homogeneous.

“Extrudable cheese paste” is understood to mean here that the cheese string obtained at the outlet of the extrusion die from this cheese paste is compliant, according to the definition of this term given above.

Beyond 0.1 the cheese paste is not extrudable at the temperatures considered and is too soft and sticky.

In addition to the maximum slope of tangent δ, the cheese base according to the invention is characterized by a softening temperature and a softening rate. The softening temperature and the softening rate of the cheese base are an indication of the capacity of the cheese base to be retextured and then extruded.

A temperature and a softening rate of the cheese base are measured before retexturation. One measurement is typically performed with one temperature ramp and another at a constant temperature.

The softening temperatures of the cheese base may be measured by conventional techniques of measuring the softening point. Softening point measurement techniques known to those skilled in the art are typically performed using a DP70 drop point measurement system (Mettler Toledo). The system comprises a cup, a sample holder, a ball, a cover and a glass collector. Typically, a sample of 0.65 g of cheese base is placed in the cup. The cup is placed on the glass collector. The ball and cover are put in place, then the assembly is hooked onto the sample holder so that the glass collector is in a vertical position. The selected temperature conditions are applied. The cheese base softens and flows under the effect of gravity inside the glass collector.

The rate and/or temperature measurement is typically recorded when the molten base reaches the 19 mm gradation.

According to a particular embodiment, the softening temperature of the cheese base before retexturation is between 60° C. and 75° C., preferably between 64° C. and 75° C.

A cheese base having a softening temperature strictly below 60° C. is too soft. The cheese paste obtained by retexturing this cheese base can not be shaped by extrusion at the temperatures in question. The cheese string obtained at the outlet of the extrusion die is then non-compliant.

A cheese base with a softening temperature clearly above 75° C. is too firm. The cheese paste obtained by retexturing this cheese base can not be shaped by extrusion at the temperatures in question. The cheese string obtained at the outlet of the extrusion die is then non-compliant.

According to this embodiment, the softening rate of the cheese base before retexturation is between 0.01 mm.s⁻¹ and 0.08 mm.s⁻¹.

Stretching the Cheese String

At the outlet of the extruder, the cheese string is stretched by a drive element. The drive element controls the string guidance, the cooling step and dictates the speed at which the cheese string is extruded. The drive element is, for example, a carpet or a roller. Subsequently, the rate at which the string is extruded through the die is called the extrusion rate. The extrusion rate is expressed in meters per minute of extruded cheese.

The drive element drives the cheese string out of the die so that the extrusion rate is greater than or equal to 2.20 meters per minute. Preferably, the extrusion rate is greater than or equal to 2.50 meters per minute.

It is pointed out that extrusion rates of less than or equal to 2 meters per minute typically correspond to the rates of extruders commonly used to produce cheese strings. In general, beyond this rate, the cheese string obtained may randomly break without the use of a cutting tool and has a non-compliant aesthetic appearance according to the criteria described above.

Optionally, the cheese string may then be molded, or undergo other transformations such as cutting with a cutting tool, winding, etc.

Cooling/Packaging

The cheese string is then packaged, preferably in the form of an individual portion. For this purpose, the cheese string is previously cooled to a temperature between 4 and 15° C.

Alternatively, the cheese string may be packaged in another form of packaging, such as paraffinic portion, pot, tray, flexible bag, aluminum portion, etc.

Characteristics of the Cheese String

The cheese string obtained by the method according to the invention typically has a solids content of between 47% and 55% by weight relative to the total weight of the cheese string.

According to a particular embodiment, the cheese string obtained has a fat content less than or equal to 20% by weight relative to the total weight of the cheese string. A fat content less than or equal to 20% is advantageous in terms of the nutritional quality of the cheese string. It is known that a cheese paste having a high fat content will have a more fluid texture at an equivalent temperature than a cheese paste having a lower fat content and will therefore be easier to extrude. The method according to the invention therefore makes it possible to obtain a continuous cheese string having a substantially constant diameter less than or equal to 10 mm, a regular cross-section, and a glossy appearance despite the fat content being less than or equal to 20%.

According to a particular embodiment, the ratio of fat/dry extract of the cheese string may be less than or equal to 40% by weight relative to the total weight of the cheese string, preferably from 20 to 40% by weight relative to total weight of the cheese string.

According to one particular embodiment of the invention, this cheese string has a fat/protein ratio less than or equal to 0.75, preferably from 0.6 to 0.7.

According to a particular embodiment, the cheese string obtained is a “string cheese”.

“String cheese” is understood to mean here any type of cheese that may be stretched into a string with a diameter between a few microns to a few millimeters because of the alignment of the proteins that constitute it.

According to a particular embodiment, the cheese string obtained is a natural cheese.

“Natural cheese” is understood to mean a cheese free of any additive as defined above.

Throughout this application, the term “comprising” should be understood to encompass all the features specifically mentioned, as well as optional, additional, or non-expressly described features. The term “comprising” also discloses the embodiment in which no features other than the specifically-mentioned features are present (i.e. “comprising” has the meaning of “consisting of”).

The invention is also illustrated by the following figures and examples which do not limit the scope thereof.

### FIGURES

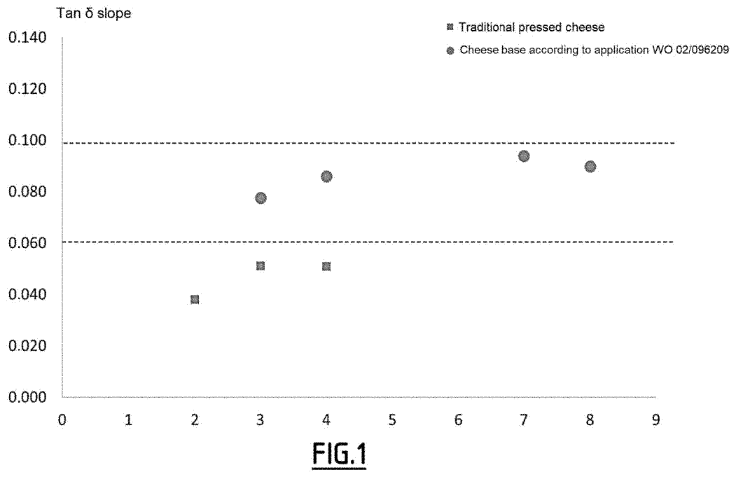

FIG. 1: Value of the maximum tan delta slope on samples of traditional pressed paste and cheese base according to Example 2 of WO 02/096209

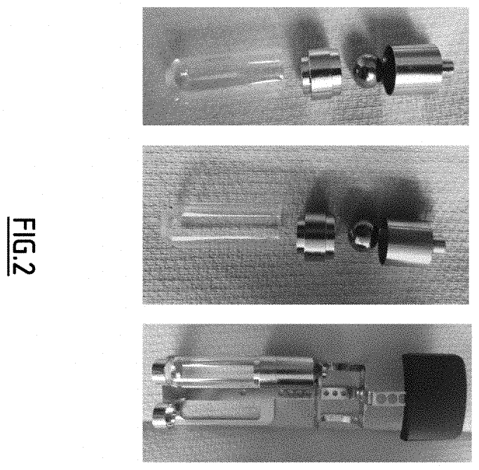

FIG. 2: Mettler Toledo DP70 drop point measuring device

FIG. 3: Example of visual inspection of the sample during the test.

### EXAMPLES

### Example 1

Measurements of the Maximum Tangent δ Slope of the Cheese Bases

1. Protocol

The measurement is carried out with a rheometer on a cheese base slice with a thickness of 1.5 to 2 mm and a diameter of 50 mm.

The sample is placed on a ribbed geometrical plane, and a normal force between 1 and 2 N is applied to ensure good contact of the product with the geometrical plane.

A temperature ramp is then applied between 20 and 80° C. at a heating rate of 1° C./min, applying a deformation of 1% at a frequency of 0.1 Hz.

2. Results

FIG. 1 represents an example of a measurement of the maximum of the tan delta slope on traditional young pressed paste and cheese bases manufactured according to example 2 of the document WO 02/096209. The term “traditional young pressed paste” is understood to mean traditional pressed paste type cheeses made less than a month before, or having an age less than or equal to 1 month. Values lower than 0.06 (traditional young pressed paste) do not make it possible to obtain finished products with a smooth and homogeneous appearance (non-compliant string). Values between 0.06 and 0.10 (case of cheese bases manufactured according to Example 2 of WO 02/096209) make it possible to obtain smooth, homogeneous and continuous (compliant) strings.

Thus, the cheese base used in the method according to the invention is not a traditional young pressed paste.

### Example 2

Temperature Measurements of Softening of the Cheese Base

1. Protocol

1—Preparation of the Sample:

A sample of 200 g of cheese base is comminuted using a garlic press and kneaded in order to obtain homogenous comminution.

2—Progress of the Measurement:

A DP70 drop point measuring system (Mettler Toledo) is used. The system includes aluminum cups, a graduated glass collector, a 2.74-gram stainless steel ball, a cover and a sample holder. The system is warmed to 30° C. A cup is tared. The basic cheese sample prepared in step 1 is placed in the cup and then packed down to remove air bubbles. The mass of the sample in the cup should be 0.65 g+/−0.01 g. The cup is placed on the glass collector. The stainless steel ball and cover are added. The assembly is positioned on the sample holder as shown on the right in FIG. 2.

Test Parameters:

Conditioning temperature: 39.5° C.

Pre-heating rate: 10° C./min

Initial test temperature: 50° C.

Temperature stabilization phase at 50° C.: 120 s

Temperature ramp from 50 to 80° C. at 2° C./min

The cheese base sample flows into the glass collector through the hole in the cup. The device uses a camera to continuously measure and record the distance traveled by the sample during the temperature ramp.

The value used is the temperature when the sample has traveled 19 mm in the glass collector.

### Example 3

Measurements of the Fixed Temperature Flow Rate of the Cheese Base

1. Protocol

The system and the sample are prepared as in Example 3 above.

Conditioning temperature: 30° C.

Pre-heating speed: 10° C./min

Initial test temperature: 63° C.

Temperature stabilization phase at 63° C.: 60 s

Temperature ramp from 63 to 64° C. at 0.1° C./min

Temperature maintenance: 700 s

The cheese base sample flows into the glass collector through the hole in the cup. The device uses a camera to continuously measure and record the distance traveled by the sample during the temperature ramp.

The value used is the time required for the sample to travel 19 mm in the glass collector.

2. Results

The system allows visual control of the appearance of the product through the camera (FIG. 3).

The product must flow without the appearance of exudate (formation of a drop of liquid during the flow).

In fact, a product exhibiting exudation is considered to be non-compliant.

A summary table of the results obtained is presented below.

TABLE 1
Summary table of results

| | | | | DP 70 | |
|---|---|---|---|---|---|
| | cooking extrusion | | | measurements | |
| | cooking | extrud- | | | flow |
| | output | able | string | T ° C. | rate |
| | aspect | Y/N | quality | softening | (mm/s) |
| Cheese base | supple, | yes | compliant | 69 | 0.033 |
| according | flowing, | | | | |
| to WO | no exudate | | | | |
| 02/096209 | | | | | |
| (Example 2) | | | | | |
| traditional | unstructured | no | / | >80 | 0.007 |
| young | heterogeneous | | | | |
| pressed | mixture | | | | |
| paste | | | | | |

### Example 4

Correlation Between the Maximum Slope of the Tangent Delta of the Cheese Bases and the Conformity of the Cheese String Obtained After Extrusion

Preparation of Cheese Bases

Several cheese bases are prepared by the method according to the invention.

A first cheese base is prepared according to Example 2 of WO 02/096209. The pH of the acidified milk before coagulation (pHe) is equal to 5.4.

A second cheese base is prepared according to Example 2 of WO 02/096209, the milk having been pasteurized at 78° C. beforehand, and the pHe being equal to 5.74.

A third cheese base is prepared according to Example 2 of WO 02/096209, the pHe being equal to 5.92.

A fourth cheese base is prepared according to Example 2 of WO 02/096209, the milk having been pasteurized at 78° C. beforehand and the pHe being equal to 5.69.

A fifth cheese base consists of a traditional young pressed dough.

Measurements of the Maximum Tangent δ Slope of the Cheese Bases

The protocol described in Example 1 is applied to the different cheese bases thus prepared.

Preparation of a Cheese Paste

Several cheese pastes are prepared by the method according to the invention from the cheese bases mentioned above.

In each case, the cheese base is comminuted using a rotating blade system conventionally used in the manufacture of meat products. A homogenous comminuted form is obtained, of homogeneous size, with a thickness between 5 mm (millimeters) and 10 mm, and with a width/length between 20 mm and 50 mm.

These chips are transferred through a preheating chamber through a double screw system. During this transfer, the comminuted cheese is heated to a temperature between 60° C. and 68+/−1° C.

The paste then undergoes an elongation step during which the temperature is maintained or adjusted to the target temperature of between 62 and 69+/−1° C. The total elongation cooking time is between 3 minutes and 9 minutes.

The cheese paste thus prepared is finally extruded through a die with a diameter less than or equal to 10 mm.

Results

Table 2 summarizes the results obtained. The values of the maximum slope of tangent delta lower than 0.06 do not make it possible to obtain finished products of smooth and homogeneous aspect (non-compliant string). Values between 0.06 and 0.10 make it possible to obtain smooth, homogeneous and continuous (compliant) strings. Values greater than 0.10 do not produce smooth and homogeneous finished products (non-compliant string).

TABLE 2
Summary table of results

| | Maximum | | Quality of the |
|---|---|---|---|
| | tangent δ | extrudable | cheese string |
| | slope | Y/N | obtained |
| cheese base | 0.093 | yes | compliant |
| according to | | | |
| patent | | | |
| application | | | |
| WO 02/096209 | | | |
| pHe 5.4 | | | |
| cheese base | 0.086 | yes | compliant |
| according to | | | |
| patent | | | |
| application | | | |
| WO 02/096209 | | | |
| pHe 5.74 | | | |
| cheese base | 0.043 | no | non-compliant |
| according to | | | |
| patent | | | |
| application | | | |
| WO 02/096209 | | | |
| pHe 5.92 | | | |
| cheese base | 0.117 | no (the paste is | non-compliant |
| according to | | extruded but the | |
| patent | | string has a rough | |
| application | | and heterogeneous | |
| WO 02/096209 | | appearance and it | |
| pHe 5.69 | | is impossible to | |
| | | ensure a | |
| | | continuous | |
| | | extrusion) | |
| young | 0.051 | no | non-compliant |
| traditional | | | |
| pressed | | | |
| paste | | | |

1. A method for manufacturing a cheese string, the method comprising the provision of a cheese base, the retexturing of this cheese base to form a cheese paste, and the extrusion of this cheese paste through a die with a diameter less than or equal to 10 mm to form the cheese string, in which the cheese base has a maximum tangent slope value δ between 0.06 and 0.10.

2. The method according to claim 1, wherein the method does not comprise the use of additives.

3. The method according to claim 1, wherein an extrusion temperature is between 62° C. and 69° C.

4. The method according to claim 1, wherein an extrusion rate is greater than or equal to 2.20 meters per minute.

5. The method according to claim 1, wherein the extrusion is carried out continuously.

6. The method according to claim 1, wherein the cheese string obtained is a string cheese.

7. The method according to claim 1, wherein a fat content by weight relative to a total weight of the cheese paste is less than or equal to 20%.

8. The method according to claim 1, wherein a ratio between a fat content by weight relative to a total weight of the cheese paste, and a dry extract by weight relative to the total weight of the cheese paste, is less than or equal to 40%.

9. The method according to claim 1, wherein a ratio between a fat content by weight relative to a total weight of the cheese paste, and a protein content by weight relative to a total weight of the cheese paste is less than or equal to 0.75.

10. A cheese string obtained by the method according to claim 1.
